(19) United States
(12) Patent Application Publication
(10) Pub. No.: US 2018/0076558 A1
(43) Pub. Date: Mar. 15, 2018

(54) MULTIFUNCTION CONNECTOR

(71) Applicant: 3M INNOVATIVE PROPERTIES COMPANY, St. Paul, MN (US)

(72) Inventors: Vincent Tan, Singapore (SG); Kok Hoe Lee, Singapore (SG); Rao Vittapalli, Singapore (SG); Yunlong Qiao, Singapore (SG); Saujit Bandhu, Singapore (SG)

(21) Appl. No.: 15/819,122

(22) Filed: Nov. 21, 2017

Related U.S. Application Data
(62) Division of application No. 14/906,995, filed on Jan. 22, 2016, now Pat. No. 9,843,125.
(60) Provisional application No. 61/861,059, filed on Aug. 1, 2013.

(51) Int. Cl. H01R 13/514; H01R 27/02; H01R 12/71

(52) U.S. Cl. CPC H01R 13/514; H01R 27/02; H01R 2107/00; H01R 12/71

(57) ABSTRACT

An electrical connector includes a unitary base elongated along a longitudinal direction. A first tongue extends forwardly from the base and has a uniform thickness along the longitudinal direction. The first tongue comprises a plurality of spaced apart first contacts. A second tongue extends forwardly from the base and comprises a plurality of spaced apart second contacts. The first and second tongues define a gap therebetween that extends from a front edge of one of the first and second tongues toward the unitary base.

### TECHNICAL FIELD

This disclosure relates generally to connectors suitable for data transmission between various devices including computer peripherals.

### BACKGROUND

Electrical cables facilitate transmission of electrical signals between devices. Cable connectors can be designed to provide interconnection between devices having a particular type of communications protocol, such as serially attached small computer interface system (SAS) and peripheral component interconnect express (PCIe). In view of the need for high speed interconnection between computers and peripheral devices, a continuing need exists for electrical cables that are capable of transmitting high speed signals, are mechanically robust, cost-effective, and can be used in a variety of applications.

### BRIEF SUMMARY

Some embodiments involve an elongated electrical connector for mounting on a printed circuit board and mating with a mating connector along a mating direction. The connector includes an elongated base extending along a longitudinal direction perpendicular to the mating direction. First and second end walls extend forwardly along the mating direction from opposite longitudinal ends of the base. A bottom tongue extends forwardly along the mating direction from the base and disposed between and spaced apart from the first and second end walls. The bottom tongue has a uniform thickness along its length along the longitudinal direction and comprising first and second bottom tongue portions separated by a third bottom tongue portion. A top tongue extends forwardly along the mating direction from the base and disposed between and spaced apart from the first and second end walls. The top tongue has a uniform thickness along its length along the longitudinal direction and is spaced apart from the bottom tongue along a thickness direction perpendicular to the mating and longitudinal directions. A bottom surface of the top tongue faces a top face of the third bottom tongue portion. A plurality of spaced apart first contacts is disposed on a top surface of the first bottom tongue portion. A plurality of spaced apart second contacts is disposed on a top surface of the second bottom tongue portion. A plurality of spaced apart third contacts is disposed on a bottom surface of the bottom tongue. A plurality of spaced apart fourth contacts is disposed on a top surface of the top tongue.

Another embodiment is directed to an electrical connector. The electrical connector includes a unitary base elongated along a longitudinal direction. A first tongue extends forwardly from the base and has a uniform thickness along the longitudinal direction. The first tongue comprises a plurality of spaced apart first contacts. A second tongue extends forwardly from the base and comprises a plurality of spaced apart second contacts. The first and second tongues define a gap therebetween that extends from a front edge of one of the first and second tongues toward the unitary base.

Yet another embodiment involves an electrical (socket) connector. The connector includes a unitary housing elongated along a longitudinal direction perpendicular to a mating direction of the connector. The unitary housing defines a central slot extending along the longitudinal direction. The central slot includes first and second slot portions separated by a third slot portion. Each slot portion comprises opposing top and bottom surfaces and a separation between the top of bottom surfaces of each slot portion along a thickness direction orthogonal to the longitudinal and mating directions defines a height of the slot. The first and second slot portions have a same smaller height and the third slot portion has a greater height. The unitary housing includes a blade extending forwardly along the mating direction from a back surface of the third slot portion. The blade is disposed between and spaced apart from the top and bottom surfaces of the third slot portion. A plurality of spaced apart first contacts is disposed on a top surface of the first slot portion. A plurality of spaced apart second contacts is disposed on a top surface of the second slot portion. A plurality of spaced apart third contacts is disposed on bottom surfaces of the first, second and third slot portions. A plurality of spaced apart fourth contacts is disposed on a top surface of the third slot portion.

In some embodiments, an electrical connector includes a unitary insulative housing defining an elongated slot bound by opposing first and second major surfaces. The housing includes a blade extending from a back surface of the slot toward a front of the slot and disposed between and spaced apart from the first and second major surfaces. A first plurality of contacts is disposed on the first major surface and facing the blade. A second plurality of contacts is disposed on the second major surface and facing the blade.

Yet other embodiments involve an electrical connector adapted to mate with a mating connector that includes overlapping planar top and bottom tongues defining a gap therebetween. Each tongue carries a plurality of contacts. The electrical connector includes an insulative planar blade, such that when the electrical connector mates with the mating connector, the insulative planar blade is inserted in the gap to provide support to at least one of the top and bottom tongues.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1A shows a perspective view of a connector in accordance with some embodiments;

FIG. 1B shows a close-up perspective view of a portion of the connector of FIG. 1A;

FIG. 1C shows a top view of the connector of FIG. 1A;

FIG. 1D shows a front view of the connector of FIG. 1A;

FIG. 2A depicts a side-cross-sectional view of the connector of FIG. 1A taken through the first and second tongues;

FIG. 2B provides a back view of a portion of the connector of FIG. 1A;

FIG. 3A illustrates a side cross-sectional view of a connector that includes a base extension in the region of the gap;

FIG. 3B is a schematic front view showing a portion of connector of FIG. 3A looking through the gap from the tongue edges towards the base;

FIG. 4A a side-cross-sectional view of a connector that includes a removable insert in the region of the gap;

FIG. 4B is a schematic front view showing a portion of connector of FIG. 4A looking through the gap from the tongue edges towards the base;

FIG. 5 is a side-cross sectional view a connector that includes a base extension used in conjunction with a removable insert;

FIGS. 6A-6D are perspective views of a multi-piece connector in accordance with some embodiments;

FIGS. 7A-7C are perspective, front, and top views, respectively, of a connector that includes multiple second tongues in accordance with some embodiments;

FIG. 8 is a perspective view a portion of a second tongue including through slots that enhance signal integrity (SI) performance of the connector;

FIG. 9A shows a perspective view of a mating socket connector in accordance with some embodiments;

FIG. 9B shows a close-up perspective view of a portion of the connector of FIG. 9A;

FIG. 9C shows a schematic depiction of a front view of the connector of FIG. 9A;

FIGS. 10A-10C are perspective views of a multi-piece socket connector in accordance with some embodiments; and

FIG. 11 is a front view of a stacked plug connector in accordance with some embodiments. In the figures, like reference numerals designate like elements.

### DESCRIPTION OF ILLUSTRATIVE EMBODIMENTS

Embodiments disclosed herein involve connectors that are suitable for providing data transmission between devices such as computer peripherals. The connectors disclosed herein include mating multi-contact connectors that can be terminated to a printed circuit board or cable.

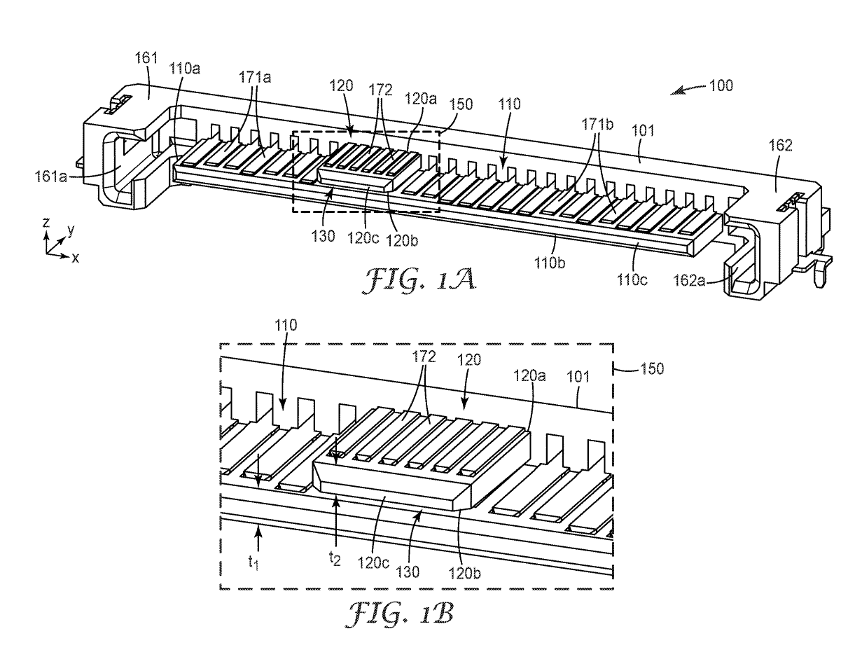

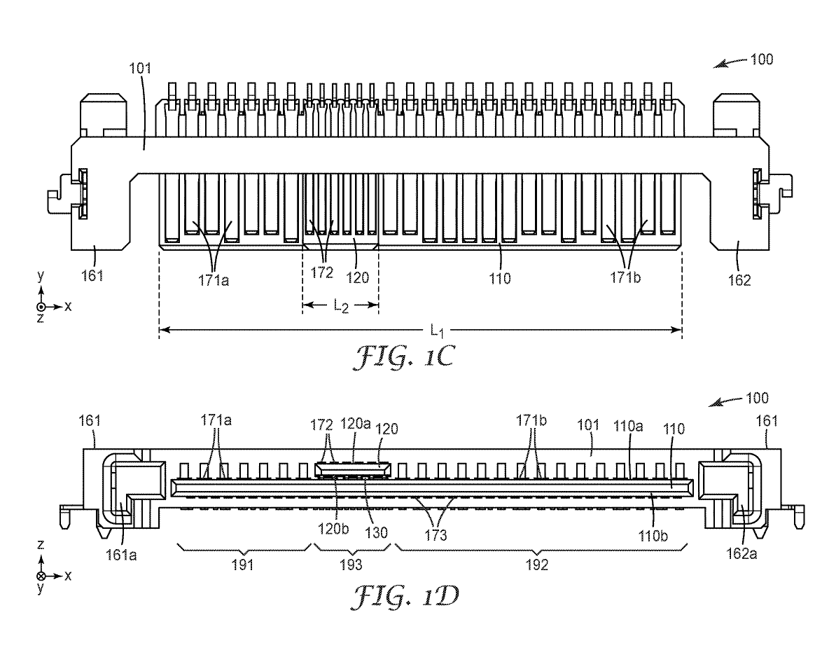

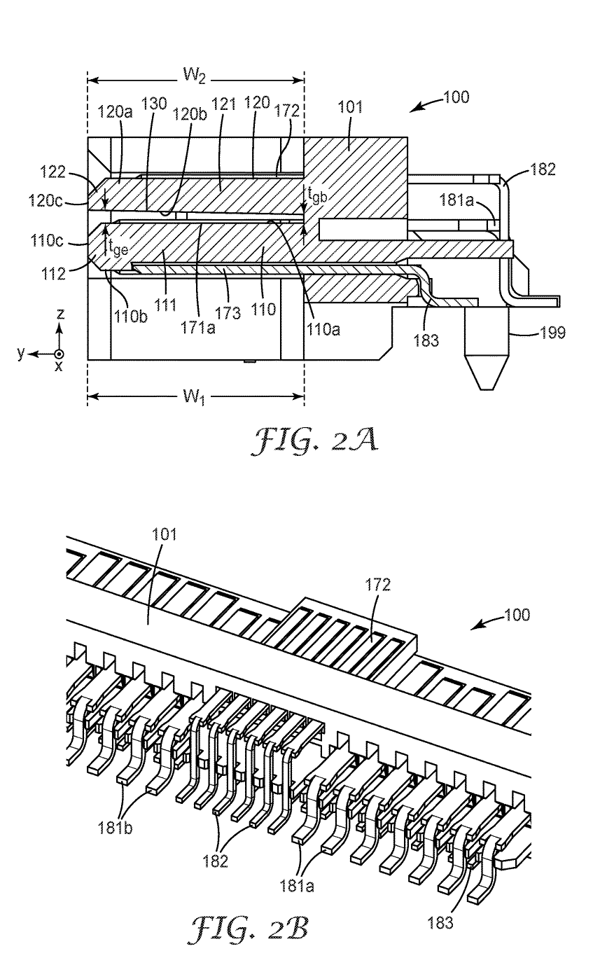

FIG. 1A shows a perspective view, FIG. 1C shows a top view, and FIG. 1D shows a front view of a connector 100 in accordance with some embodiments. FIG. 1B shows a close up perspective view of a portion 150 of connector 100. Connector 100 is also referred to herein as a “plug” or “plug connector.” The connector 100 includes a base 101 that is elongated along a longitudinal direction (the x-direction as indicated in FIG. 1A) that is perpendicular to a mating direction (the y-direction as indicated in FIG. 1A). End walls 161, 162 extend forwardly along the mating axis from opposite longitudinal ends of the base 101. In some embodiments, the base 101 is formed as a unitary, one-piece construction. In some embodiments the base 101 and the end walls 161, 162 are formed as a unitary, one-piece construction.

The connector 100 includes a first tongue 110 and a second tongue 120. Each of the first and second tongues 110, 120 extends from the base 101 forwardly along the mating axis. In some embodiments, the base 101, the first and second tongues 110, 120, and the first and second end walls 161, 162 form a unitary construction. Unitary constructions are one-piece constructions that may be formed of a polymeric material, plastic or any insulating material by molding, machining, and/or extruding, for example.

The first tongue 110 is disposed between the end walls 161, 162 and in some embodiments the first tongue 110 is spaced apart from the end walls 161, 162. The first tongue 110 has a first surface 110a and a second surface 110b, and may have a plurality of electrical contacts 171a, 171b spaced apart and disposed on the first surface 110a. The first tongue 110 may have a plurality of electrical contacts 173 disposed on the second surface 110b.

The connector 100 includes a second tongue 120 that extends from the base 101 forwardly along the mating axis. The second tongue 120 is disposed between the first and second end walls 161, 162 and may be spaced apart from the end walls 161, 162. The second tongue 120 has a first surface 120a and a second surface 120b. A plurality of electrical contacts 172 may be spaced apart and disposed on the first surface 120a. The first surface 110a of the first tongue 110 and the second surface 120b of the second tongue 120 are separated by a gap 130. In the orientation illustrated in FIG. 1D, the first tongue 110 is oriented below the second tongue 120. Thus, the first tongue 110 may be referred to herein as the “bottom tongue” and the second tongue 120 may be referred to as the “top tongue,” although the reader will understand that the terms “top” and “bottom” are merely used for identification of the first and second tongues 110, 120 and not meant to limit the embodiments to any particular connector orientation.

Electrical contacts may be disposed on the second surface 120b of the second tongue 120 if the separation distance between the first surface 110a of the first tongue 110 and the second surface 120b of the second tongue 120 is sufficient to support electrical contacts on both surfaces 110a, 120b. However, in many cases, as shown in FIGS. 1A-1D, there are no electrical contacts on the second surface 120b of the second tongue 120 and there are also no electrical contacts on the first surface 110a of the first tongue 110 in the region of the gap 130 where the second tongue 120 overlaps the first tongue 110.

FIG. 1B is a close-up view of the portion 150 of connector 100 that shows the region of the gap 130 where the second tongue 120 overlaps the first tongue 110.

As best seen in FIG. 1C, the first tongue 110 has a length, L₁, extending along the longitudinal direction (x-direction) of the connector 100 and the second tongue 120 has a length, L₂, extending along the longitudinal direction. In general, the lengths L₁ and L₂ may be related to the number of electrical contacts needed for the connector, and may be any lengths suitable for the connector 100. In some embodiments, the top surface of the first tongue carries about 22 contacts, the bottom surface of the first tongue carries about 40 contacts and the top surface of the second tongue carries about 6 contacts, although the number of contacts can vary according to the implementation for which the connector is used. Lengths L₁ and L₂ may be equal to each other, L₁=L₂, or may be different from each other, e.g., L₂<L₁. For example, L₁ may be several times larger than L₂, e.g., L₁ may be about 30 mm to 37 mm and L₂ may be about 7 mm to 12 mm.

In some embodiments, the first tongue 110 has uniform thickness along the longitudinal x-direction and the mating y-direction. For example, the first tongue 110 can have a thickness of about 0.7 mm to 1.70 mm, or about 1.0 mm to 2.35 mm. In some embodiments, the first tongue has a uniform thickness along the longitudinal direction (x-direction) and the mating direction (y-direction). For example, the second tongue 120 can have a thickness of about 0.5 mm to 3.0 mm, or about 1.2 mm to 5.5 mm.

The thicknesses, t₁, t₂, of the first and second tongues 110, 120 can be equal to each other, t₁=t₂, or they can be different from each other, t₁>t₂, or t₁<t₂. In some embodiments, the first tongue 110 is uniformly thicker than the second tongue 120 along the longitudinal axis (x-axis in FIG. 1A). In some embodiments, the first tongue 110 is uniformly thinner than the second tongue 120 along one or more of the longitudinal axis (x-axis in FIG. 1A). The first and/or second tongues 110, 120 may have an edge 110c, 120c that is beveled, rounded, chamfered, or blunt.

The thickness, t₁, of the first tongue 110 may or may not be uniform along the mating axis. For example, the thickness, t₁, of the first tongue 110 may taper (increase or decrease) from a first thickness, t_{1b}, at the base 101 to a second thickness, t₁ₑ, at the edge 110c. The first thickness, t_{1b}, may be greater than t₁ₑ, t_{1b}>t₁ₑ, or t_{1b} may be less than t₁ₑ, t_{1b}<t₁ₑ. The thickness, t₂, of the second tongue 120 may or may not be uniform along the mating axis. For example, the thickness, t₂, of the second tongue 120 may taper from a first thickness, t_{2b}, at the base 101 to a second thickness, t₂ₑ, at the edge 120c. The first thickness, t_{2b}, may be greater than t₂ₑ, t_{2b}>t₂ₑ, or t_{2b} may be less than t₂ₑ, t_{2b}<t₂ₑ. The thicknesses of the first and/or second tongues may increase or decrease linearly, non-linearly, or piece-wise linearly, for example.

In some embodiments, the connector 100 includes end walls 161, 162 disposed at one or both ends of the base 101 and extending from the base 101 forwardly along the mating direction. The end walls 161, 162 may comprise optional channels 161a 162a. The channels 161a, 162a, shown as U-shaped in FIGS. 1A, 1C, and 1D, can be any convenient shape and are configured to slidably engage with compatible protrusions of a mating connector (not shown in FIG. 1A).

As best seen in FIG. 1D, the first tongue 110 can comprise a first portion 191 and a second portion 192 separated by a third portion 193. The connector 100 includes a plurality of spaced apart first electrical contacts 171a disposed on the first surface 110a of the first tongue 110 in the first portion 191; a plurality of spaced apart second electrical contacts 171b disposed on the first surface 110a of the first tongue 110 in the second portion 192, and a plurality of third electrical contacts 173 disposed on the second surface 110b of the first tongue 110 in the first, second, and/or third portions 191, 192, 193.

The connector 100 includes a second tongue 120 that includes plurality of spaced apart electrical contacts 172 disposed on the first surface 120a of the second tongue 120. In some embodiments, there are no electrical contacts on the first surface 110a of the first tongue 110 in the third portion 193. In some embodiments, there are no electrical contacts disposed on the second surface 120b of the second tongue 120.

FIG. 2A depicts a side cross sectional view of the connector 100 taken through the first and second tongues 110, 120. The first tongue 110 extends forwardly from the base 101 and has a width, W₁, extending from the base 101 to the edge 110c. The second tongue 120 extends forwardly from the base 101 and has a width, W₂, extending from the base 101 to the edge 120c. In some embodiments, as shown in FIG. 2A, W₁=W₂. However, in other embodiments, W₁ may be greater or less than W₂. In some implementations, and with reference to FIG. 1D, the widths of the first tongue 110 in first portion 191, second portion 192, and third portion 193 may not be equal. For example, in some configurations the width of the third portion 193 is smaller than the widths of the first and/or second portions 191, 192.

As depicted in FIG. 2A, the first tongue 110 can include a first major region 111 at or nearest to the base 101 and a beveled region 112 near the edge 110c where one or both surfaces 110a, 110b are beveled. The second tongue 120 can include a first major region 121 at or nearest to the base 101 and beveled region 122 at the edge 120c where one or both surfaces 120a, 120b are beveled. In the implementation depicted in FIG. 2A, both surfaces 110a, 110b of the first tongue 110 are beveled, the first surface 120a of the second tongue is beveled, and the second surface 120b of the second tongue 120 is not beveled.

FIG. 2A shows the gap 130 between the tongues 110, 120 and other structures of connector 100 in accordance with some embodiments. The gap 130 is formed between the first surface 110a of the first tongue 110 and the second surface 120b of the second tongue 120. In many embodiments, the first surfaces 110a, 120a and second surfaces 110b, 120b are substantially planar. The gap 130 has a thickness, t_{g}, along the z axis that may be uniform, or may vary along the mating y or longitudinal x-axes. In some embodiments, t_{g} is in a range of about 0.1 mm to about 5 mm, or about 0.1 mm to about 2 mm, or about 0.1 to about 1 mm. In some cases, t_{g} is uniform with respect to the mating y and longitudinal x-axes.

In some cases, t_{g} may vary with respect to the y and/or x axes. FIG. 2 indicates the thickness, t_{gb}, of the gap 130 at or nearest to the base 101 of the connector 100. FIG. 2A indicates the thickness, t_{ge}, of the gap 130 near an edge 110c, 120c of the first or second tongues 110, 120 taken between an unbeveled region of the first surface 110a and unbeveled region of the second surface 120b. In various implementations, t_{gb} may be equal to t_{ge}, and the thickness of the gap along the mating axis is uniform. Alternatively, the thickness of the gap 130 may be tapered toward the base along the mating axis, wherein t_{ge}>t_{gb} and the gap 130 linearly decreases along the mating axis from t_{ge} to t_{gb}. Alternatively, the gap 130 may be tapered toward the edge, wherein t_{gb}>t_{ge} and the gap 130 linearly decreases along the mating axis from t_{gb} to t_{ge}.

The cross-sectional view of FIG. 2A shows electrical contacts 171a disposed on the first surface 110a of the first tongue 110, electrical contacts 173 disposed on the second surface 110b of the first tongue 110, and electrical contacts 172 disposed on the first surface 120a of the second tongue 120. In many embodiments, such as the one depicted in FIG. 2A, the second tongue 120 does not include electrical contacts on its second surface 120b and the first tongue 110 does not include electrical contacts on its first surface 110a in the region of the gap 130.

As shown in FIG. 2A, the electrical contacts 171a, 173, 172 have leads 181a, 183, 182, respectively, extending backwardly along the mating axis beyond the base 101. In this particular embodiment, leads 181a, 183, 182 are configured for surface mounting on a printed circuit board. In other embodiments, the leads may be configured for through-hole mounting.

The connector 100 shown in FIG. 2A and some other connectors shown herein are the right-angle mount connectors. It will be appreciated that approaches disclosed herein are also applicable to connectors that are configured to mount vertically on a printed circuit board. FIG. 2A depicts an alignment peg 199 oriented for right angle mounting and configured to align the connector on the printed circuit board. Alignment pegs may also be used in vertical mount embodiments. In embodiments that involve stacked connectors, alignment pegs may be used to align adjacent stacked connectors.

FIG. 2B provides a back perspective view of a portion of connector 100, showing the base 101, electrical contacts 172, and electrical leads 181a, 181b, 182, and 183.

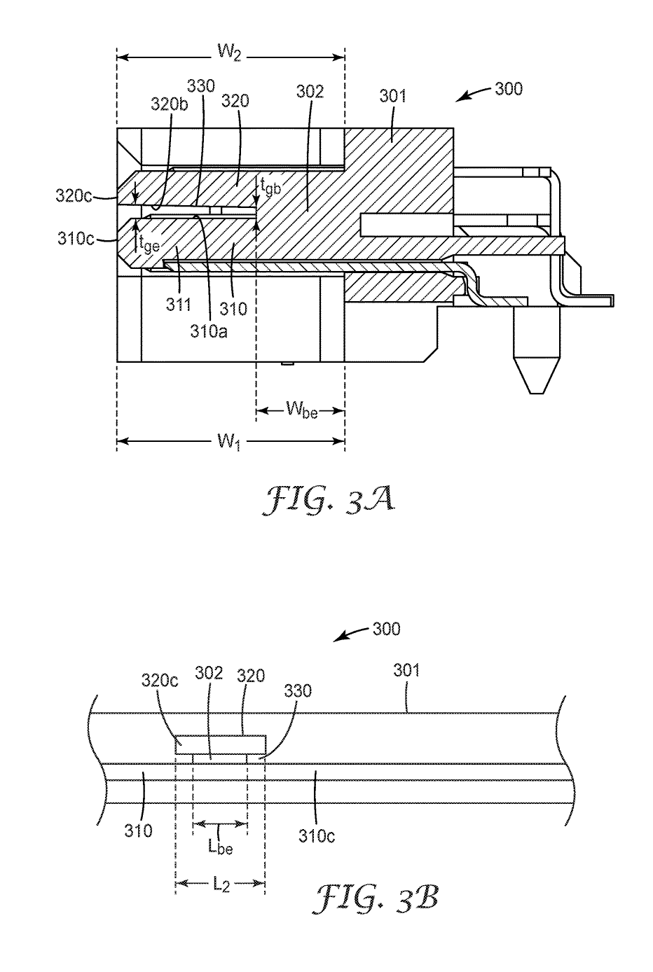

FIG. 3A illustrates a connector 300 that includes some features similar to those of connector 100. Additionally, connector 300 includes a base extension 302 in the region of the gap 330. The base extension 302 extends forwardly from the base 301 along the mating y-axis. In many embodiments, the base extension 302 has a width, W_{be}, that is less than the width, W₁, of the first tongue 310, and/or less than the width, W₂, of the second tongue 320. For example, the width, W_{be}, of the base extension 302 may be about 50% or less than the width, W₁, of the first tongue 310 and/or may be about 50% or less than the width, W₂, of the second tongue 320. The base extension 302 can be configured to provide additional structural support to the first and/or second tongues 310, 320.

The gap 330 has a thickness, t_{g}, that, in some embodiments, may be uniform along the longitudinal x-axis and/or may be uniform along the mating y-axis. In some embodiments, the gap may taper along the mating y-axis. FIG. 3A indicates the thickness, t_{gbe}, of the gap 330 at or nearest to the base extension 302 and the thickness of the gap, t_{ge}, located near an edge 310c, 320c of the first or second tongues 310, 320. Thickness, t_{ge}, is the distance between an unbeveled region of the first surface 310a of the first tongue 310 and unbeveled region of the second surface 320b of the second tongue 320. In some embodiments, t_{gbe} may be equal to t_{ge}, providing a gap that is uniform along the mating y axis. In some embodiments, the gap 330 may be tapered toward the base extension 302, wherein t_{ge}>t_{gbe} and the thickness of the gap 330 decreases linearly from t_{ge} to t_{gbe}. In some embodiments, the gap 330 may be tapered toward the edge, wherein t_{gbe}>t_{ge} and the thickness of the gap 330 decreases linearly from t_{gbe} to t_{ge}.

FIG. 3B is a schematic front view showing a portion of connector 300 looking through the gap 330 from the edges 320c, 330c towards the base 301. FIG. 3B shows a portion of the first tongue 310 and the second tongue 320 and the gap 330 between the first and second tongues 310, 320. The base extension 302 extends from the base 301 towards the front edges 310c, 320c. The base extension 302 has a length, L_{be}, that in many cases is the same as the length, L₂, of the second tongue 320. In some embodiments, such as the illustrated embodiment of FIG. 3B, the length of the base extension, L_{be}, is less than the length, L₂, of the second tongue. It is also possible for L_{be} to be larger than L₂.

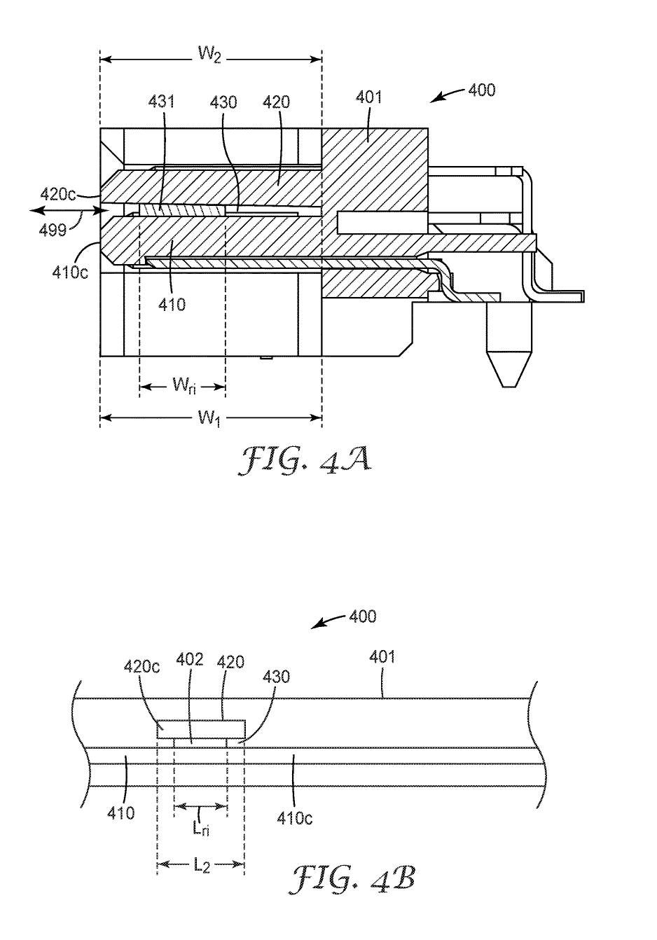

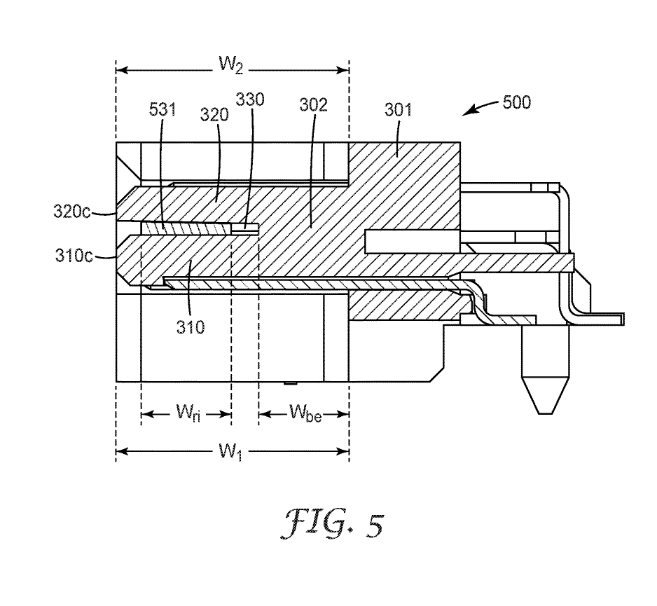

FIG. 4A illustrates a connector 400 that is similar in some respects to connector 100. Connector 400 includes a removable insert 431 in the region of the gap 430. The removable insert 431 may be made of plastic or other material and can have structural characteristics capable of providing additional load support to the first and/or second tongues 410, 420. The removable insert 431 has a width, Wᵣᵢ, that can be equal to or less than the width, W₁, of the first tongue 410, and/or equal to or less than the width, W₂, of the second tongue 420. For example, the width, Wᵣᵢ, of the removable insert 431 may be about 50% or less than the width, W₁, of the first tongue 410 and/or may be about 50% or less than the width, W₂, of the second tongue 420.

The removable insert 431 may be placed at any location in the gap 430 along the x and y-axes. For example, the removable insert 431 can be placed proximate to the base 401, at a location within the gap that is substantially centered along the mating y axis, or at a location proximate to the front edges 410c, 420c. Arrow 499 indicates that the removable insert 431 can be inserted and removed from the gap 430, e.g., from the front of connector 400. In some implementations, the removable insert is removed before the connector 400 mates with a mating connector.

FIG. 4B is a schematic front view showing a portion of connector 400 looking through the gap 430 from the edges 420c, 430c towards the base 401. FIG. 4B shows a portion of the first tongue 410, and shows the second tongue 420 with the gap 430 between the first and second tongues 410, 420. The removable insert 431 is shown disposed within the gap 430. The removable insert 431 has a length, Lᵣᵢ, that in many cases is the same as the length, L₂, of the second tongue 420. In some embodiments, such as the illustrated embodiment of FIG. 4B, the length, Lᵣᵢ, of the removable insert 431 is less than the length, L₂, of the second tongue 420. It is also possible for Lᵣᵢ to be larger than L₂.

Connector 500 shown in FIG. 5 is similar in many respects to connector 300. Connector 500 shows that a base extension 302 may be used in conjunction with a removable insert 531 in some embodiments.

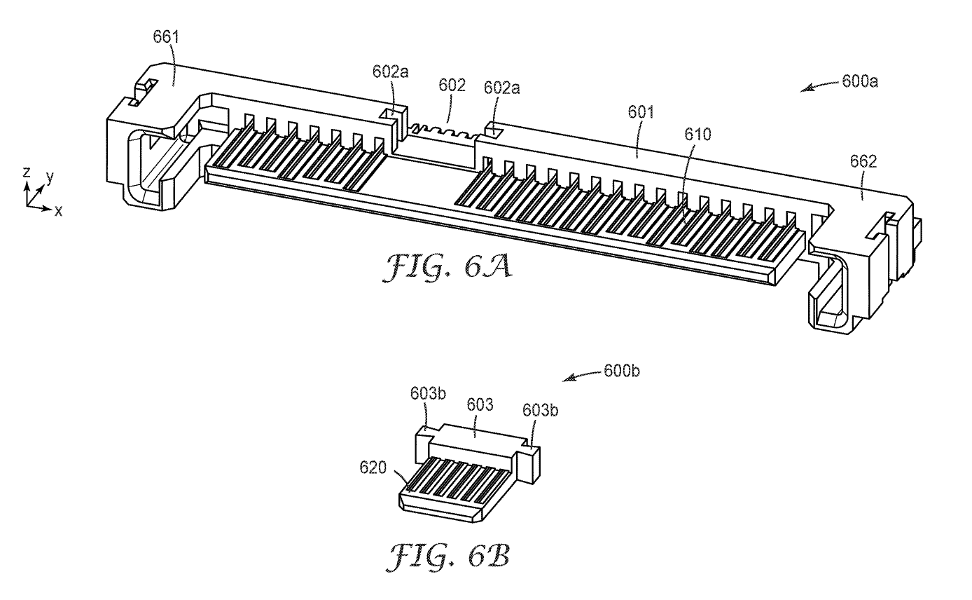

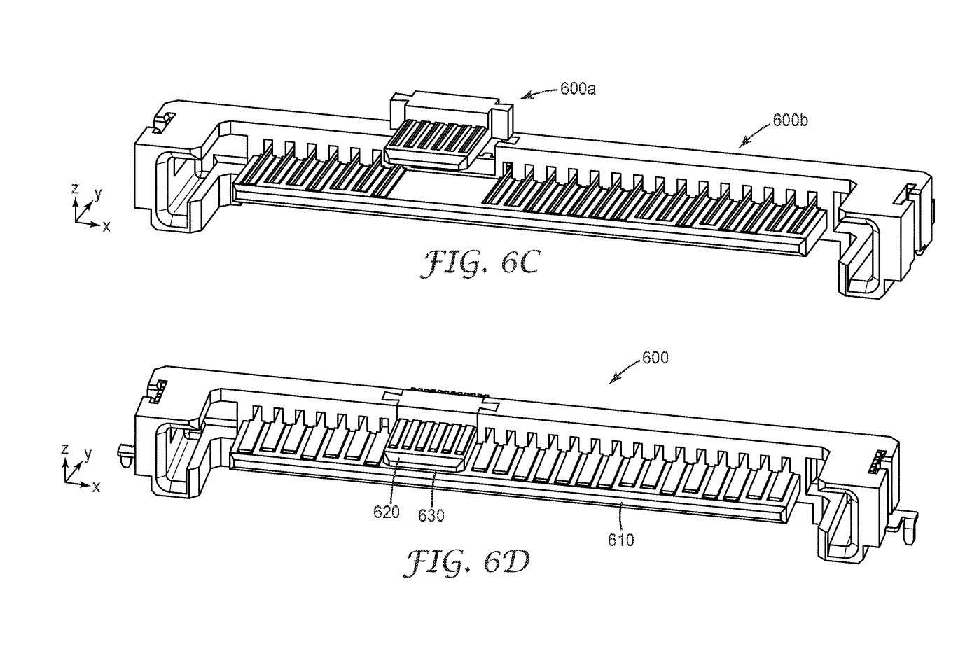

FIGS. 6A-6D illustrate a multi-piece connector in accordance with some embodiments. FIGS. 6A and 6B show first and second connector pieces 600a, 600b, respectively, of a connector that can be assembled so that the assembled connector (600, FIG. 6D) has a first tongue 610 and a second tongue 620 with a gap 630 disposed therebetween. In this embodiment, the second connector piece 600b is reversibly attachable to and removable from the first connector piece 600a. The first connector piece 600a includes mating features that are configured to mate with compatible mating features of the second connector piece 600b, e.g., by snap-fit, friction-fit, or other mechanism.

As depicted in FIGS. 6A-6D, the first connector piece 600a includes a base 601 that is elongated along a longitudinal direction (the x-direction as indicated in FIG. 6A) that is perpendicular to a mating direction (the y-direction as indicated in FIG. 6A). The first connector piece 600a can include end walls 661, 662 that extend forwardly along the mating y axis from opposite longitudinal ends of the base 601.

In this embodiment, the base 601 includes mating features comprising a slot 602 configured to engage with mating features of the second connector piece 600b Channels 602a may be disposed on opposing sides of the slot 602 in the base 601. The channels 602a are configured to mate with compatible protrusions 603b of the second piece 600b. In at least one configuration, the channels 602a and compatible protrusions 603b may have a dovetail shape.

The second connector piece 600b, is sometimes referred to as a sliding portion because, in some embodiments, the second piece 600b is slidably attachable to the first connector piece 600a. The second connector piece 600b includes a tab 603 dimensioned to fit at least partially within the slot 602. Protrusions 603b extend on either side of the tab 603 along the longitudinal x-axis. The protrusions 603b of the second connector piece 600b can be configured to slidably engage with the channels 603a of the first connector piece 600a.

FIG. 6C illustrates the first and second connector pieces, 600a, 600b during the assembly process. FIG. 6C shows the first and second connector pieces 600a, 600b aligned for assembly before the channels 602a have completely engaged the protrusions 603b. FIG. 6D shows the assembled connector 600 after the channels 602a are completely engaged with the protrusions 603b. The assembled connector 600 shown in FIG. 6D includes a first tongue 610 and a second tongue 620 with a gap 630 between the first and second tongues 610, 620. After assembly, connector 600 can have electrical contacts and other features similar to the configuration of connector 100, for example.

In some embodiments, the first connector piece or the second connector piece may include a base extension, so that the assembled connector has a configuration similar to the configuration of connector 300. In yet other embodiments, a removable insert may be placed between the first and second tongues before the second piece is assembled to the first piece. In this embodiment, the assembled connector has a configuration similar to the configuration of connector 400.

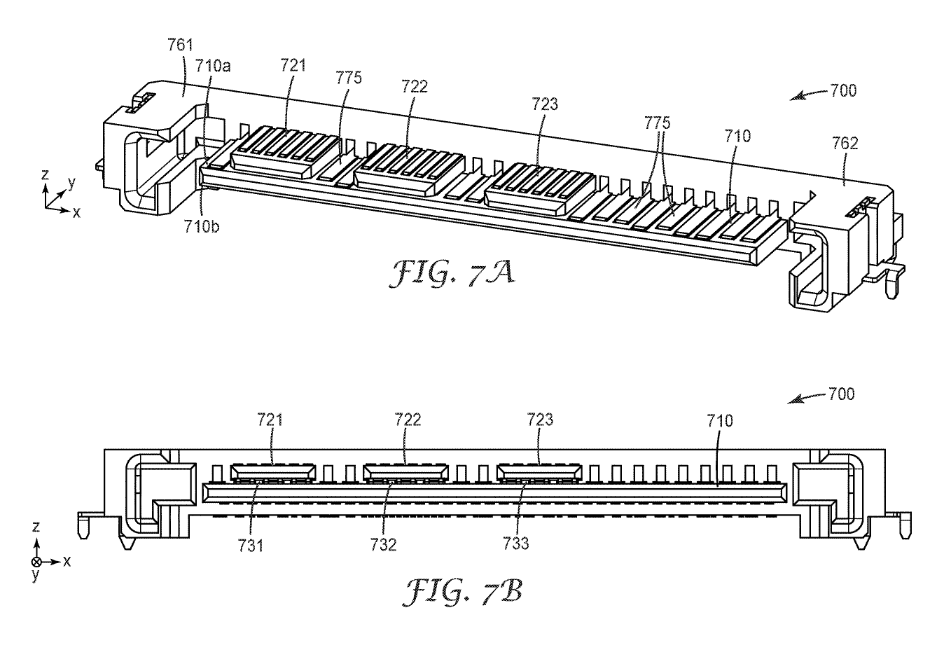

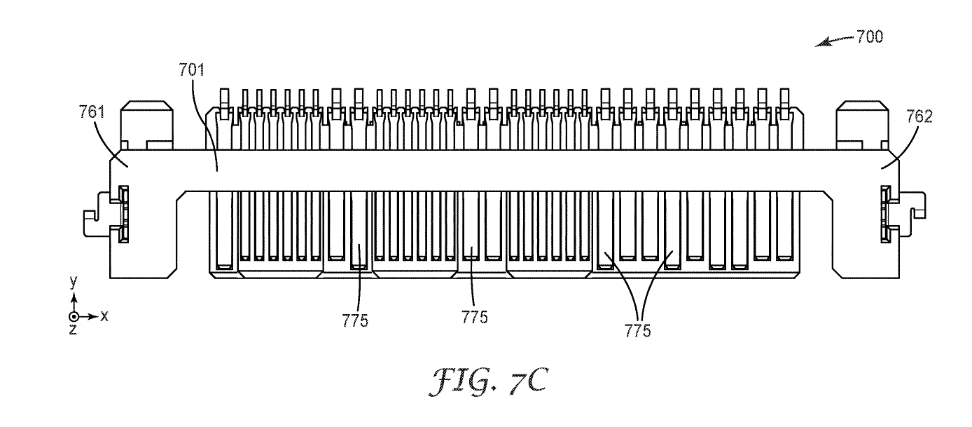

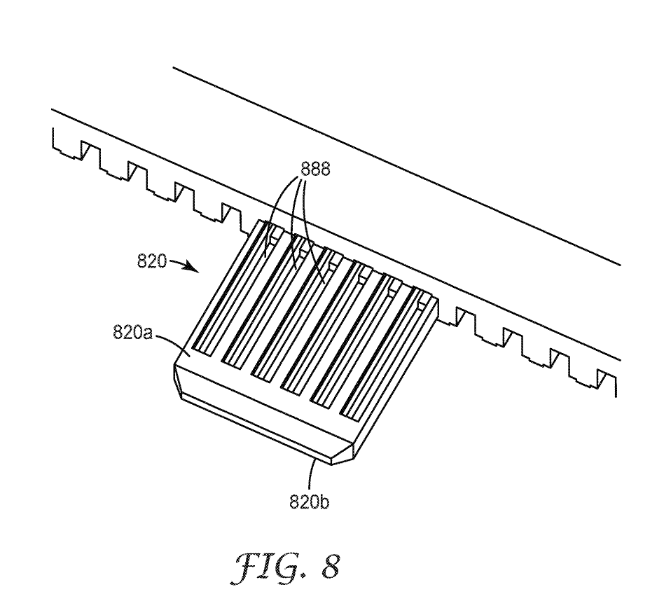

Some embodiments involve connectors that include multiple second tongues, as shown in FIGS. 7A-7C. FIGS. 7A, 7B, and 7C, show a perspective view, a front view, and a top view, respectively, of a connector 700 that includes a first tongue 710 and three second tongues 721, 722, 723. The connector 700 includes a base 701 that is elongated along a longitudinal x-axis. End walls 761, 762 extend forwardly along the mating y-axis from opposite longitudinal ends of the base 701. In some embodiments, the base 701 comprises a unitary, one-piece construction. In some embodiments the base 701 and the end walls 761, 762 are formed as a unitary, one-piece construction.

The connector 700 includes a first tongue 710 and a second tongues 721, 722, 723. Each of the tongues 710, 721, 722, 723 extends from the base 701 forwardly along the mating y-axis. In some embodiments, the base 701, the first and second tongues 710, 721, 722, 723, and the first and second end walls 761, 762 form a unitary construction.

The first tongue 710 is disposed between the end walls 761, 762 and may be spaced apart from the end walls 761, 762. The first tongue 710 has a first surface 710a and a second surface 710b, and may have a plurality of electrical contacts 775 spaced apart and disposed on the first surface 710a. The first tongue 710 may have a plurality of electrical contacts disposed on the second surface 710b.

The connector 700 includes a multiple second tongues 721, 722, 723 that extend from the base 701 forwardly along the mating y-axis. The second tongues 721, 722, 723 are disposed between the first and second end walls 761, 762 and may be spaced apart from the end walls 761, 762. The second tongues 721, 722, 723 have first surfaces 721a, 722a, 723a and second surfaces 721b, 722b, 723b. A plurality of electrical contacts 771, 772, 773 may be spaced apart and disposed on the first surfaces 721a, 722a, 723a of the tongues 721, 722, 723. The first surface 710a of the first tongue 710 and the second surfaces 721b, 722b, 723b of the second tongue 721, 722, 723 are separated by gaps 731, 732, 733.

In many cases, as shown in FIGS. 7A-7D, there are no electrical contacts on the second surface of the second tongue and there are also no electrical contacts on the first surface of the first tongue in the regions of the gaps 731, 732, 733 where the second tongues 721, 722, 723 overlap the first tongue 710.

In some embodiments, one or more of the second tongues 721, 722, 723 may be disposed on a second connector piece that is reversibly attachable to and removable from a first connector piece that includes the first tongue 710, as previously discussed for a single second tongue in connection with FIGS. 6A-6D. In these embodiments, the connector can be adaptable to achieve a variety of second tongue configurations depending on application.

FIG. 8 illustrates a portion of a second tongue 820 configured to facilitate impedance matching and to enhance signal integrity (SI) performance of the connector. FIG. 8 shows a top perspective view of a second tongue 820 without electrical contacts. In this view, the second tongue 820 includes through slots 888 spaced apart along the second tongue 820. The through slots 888 extend from the first surface 820a of the second tongue through the second surface 820b of the second tongue 820. The through slots 888 form air gaps under the electrical contacts after the electrical contacts are installed on the second tongue 820. The air gaps enhance impedance matching and signal integrity (SI) performance of the connector.

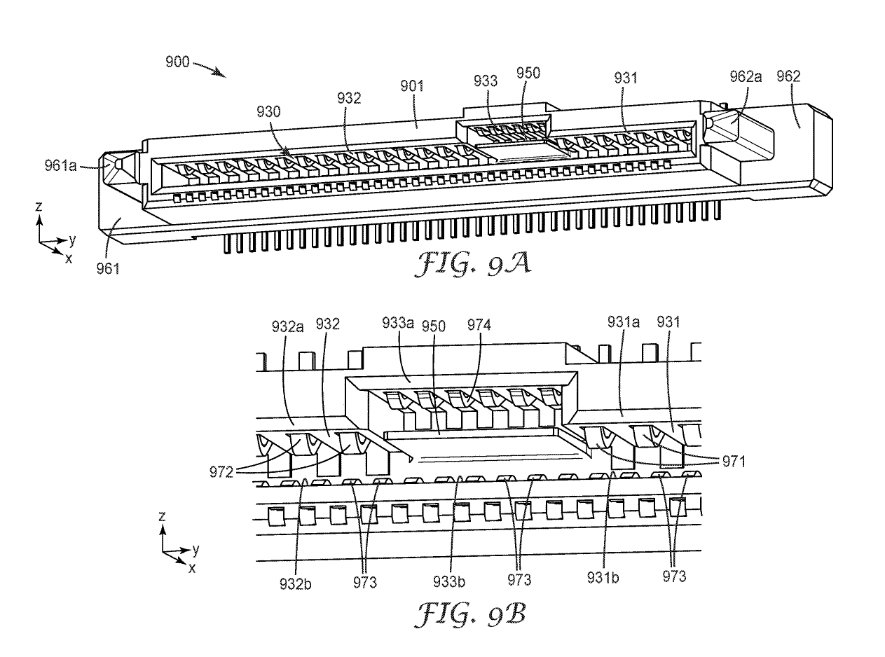

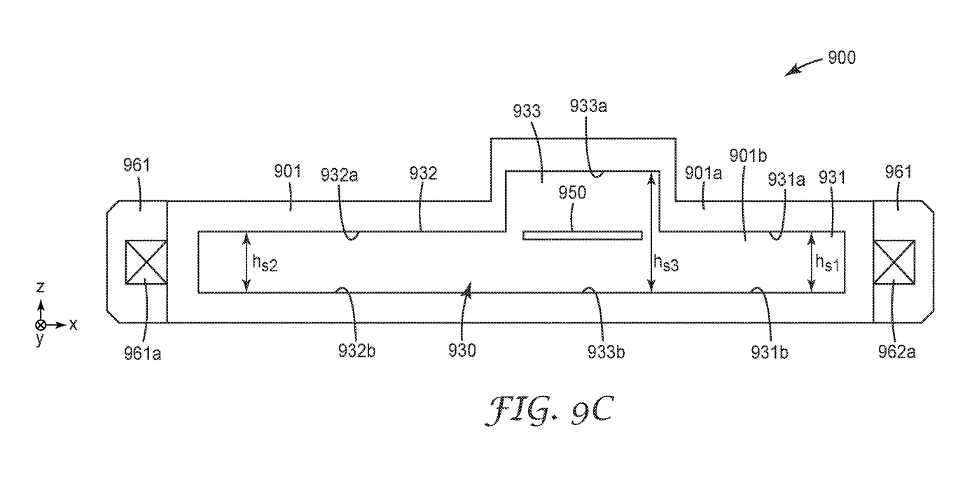

Some embodiments are directed to mating socket connectors configured to mate to the plug connectors described, for example, in connection with FIGS. 1-8. FIG. 9A shows a perspective view of a mating socket connector 900 in accordance with some embodiments and FIG. 9B shows a close-up perspective view of a portion of connector 900. FIG. 9C shows a schematic depiction of a front view of the connector 900. The connector 900 includes a housing 901 that is elongated along a longitudinal direction (the x-direction in FIGS. 9A-9C) perpendicular to a mating direction (the y-direction in FIGS. 9A-9C) of the connector 900. In some embodiments, the housing may be a multi-piece housing. In some embodiments, the housing, including the blade 950, may be formed as a unitary housing. Whether unitary or multi-piece, the housing 901 can be made of an insulative material such as plastic. The housing 901 comprises a central slot 930 extending along the longitudinal x direction. The central slot 930 includes a first slot portion 931 and second slot portion 932 separated by a third slot portion 933.

Each slot portion 931, 932, 933 includes opposing top and bottom surfaces. As best seen in FIG. 9C, the first slot portion 931 includes opposing top and bottom surfaces 931a, 931b; the second slot portion 932 includes opposing top and bottom surfaces 932a, 932b; and the third slot portion 933 includes opposing top and bottom surfaces 933a, 933b. A separation between the top of bottom surfaces of each slot portion along a thickness direction (z-direction in FIGS. 9A-9C) orthogonal to the longitudinal and mating directions defines a height of the slot 930. The first slot portion 931 has a height, hₛ₁; the second slot portion 932 has a height, hₛ₂; and the third slot portion 933 has a height, hₛ₃. In some embodiments hₛ₁=hₛ₂ and hₛ₁ and hₛ₂ are less than hₛ₃. In some implementations, one or more of the heights hₛ₁, hₛ₂, hₛ₃, are uniform along the mating y axis. In some embodiments one or more of the heights hₛ₁, hₛ₂, hₛ₃ may vary along the mating y axis between the mating surface 901a and the back surface 901b.

The housing 901 comprises a blade 950 that extends forwardly along the mating y-axis from a back surface 901b of the third slot portion 933. The blade 950 may have a planar configuration and is disposed between and spaced apart from the top and bottom surfaces 933a, 933b of the third slot portion 933. The blade 950 may not extend into the first and second slot portions 931, 932. In some embodiments, the blade 950 can be made of insulative material. In some embodiments, the blade 950 does not carry any contacts.

In some embodiments, the bottom surfaces 931b, 932b, 933b of the first, second and third slot portions 931, 932, 933 lie in the same plane. In some embodiments, the top surfaces 931a, 932a of the first and second slot portions 931, 932 lie in the same plane and the top surface 933a of the third slot portion 933 lies in a different plane from the top surfaces 931a, 932a of the first and second slot portions 931, 932, e.g., a plane that is higher along the z-direction as depicted in FIG. 9A.

As best seen in FIGS. 9A and 9B, the connector 900 includes a plurality of spaced apart electrical contacts including a plurality of first contacts 971 disposed on a top surface 931a of the first slot portion 931; a plurality of spaced apart second contacts 972 disposed on a top surface 932a of the second slot portion 932; a plurality of spaced apart third contacts 973 disposed on bottom surfaces 931b, 932b, 933b of the first, second and third slot portions 931, 932, 933; and a plurality of spaced apart fourth contacts 974 disposed on a top surface 933a of the third slot portion 933.

The electrical connector 900 shown in FIGS. 9A-9C is configured to mate with a mating connector having spaced apart top and bottom tongues defining a gap therebetween, as illustrated, for example, by FIGS. 1-8. The first and second slot portions 931, 932 mate with the first (bottom) tongue, the third slot portion 933 mates with the second (top) tongue, and the blade 950 is inserted in the gap. The blade 950 provides support to at least one of the top and bottom tongues.

In some embodiments, the housing 901 includes end tabs 961, 962 that extend along the longitudinal x-axis. The tabs 961, 962 can include protrusions 961a, 962a that extend forwardly along the mating y-axis and are configured to slidably engage with the U-shaped channels disposed in the end walls of a mating connector.

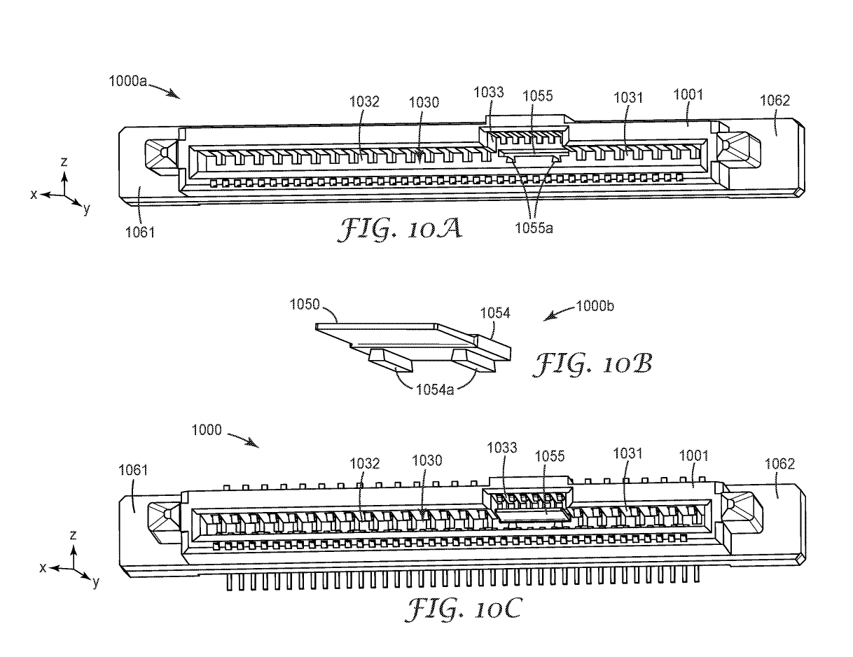

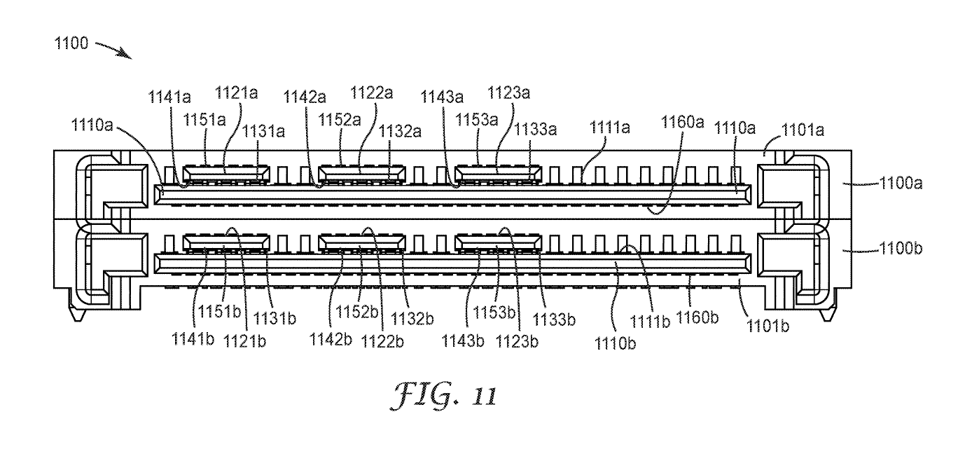

FIGS. 10A-10C illustrate a multi-piece socket connector in accordance with some embodiments. FIGS. 10A and 10B shows first and second connector pieces 1000a, 1000b, respectively, of a socket connector that can be assembled to form connector 1000 shown in FIG. 10C. In this embodiment, the second connector piece 1000b is reversibly attachable to and removable from the first connector piece 1000a. The first connector piece 1000a includes mating features that are configured to mate with compatible mating features of the second connector piece 1000b, e.g., by snap-fit, friction-fit, or other mechanism.

As depicted in FIGS. 10A-10C, the first connector piece 1000a includes a housing 1001 that is elongated along a longitudinal direction (the x-direction as indicated in FIG. 10A) and that is perpendicular to a mating direction (the y-direction as indicated in FIG. 10A). The first connector piece 1000a can include end tabs 1061, 1062 that extend longitudinally along the longitudinal x-axis at opposite longitudinal ends of the housing 1001.

The housing 1001 comprises a central slot 1030 extending along the longitudinal direction. The central slot 1030 comprises a first slot portion 1031 and second slot portion 1032 separated by a third slot portion 1033. As shown in FIG. 10A, the first connector piece 1000a includes an opening 1055 (or slot) in the back surface 1001b of the housing 1001 in the third slot portion 1033. The opening 1055 is dimensioned to accept the second connector piece 1000b. The opening 1055 can include channels 1055a configured to mate with compatible protrusions 1054a of the second connector piece 1000b. In at least one aspect, the channels 1055a and compatible protrusions 1054a may have a dovetail shape.

The second connector piece 1000b shown in FIG. 10B is dimensioned to be slidably attachable to the first connector piece 1000a. The second connector piece 1000b includes a tab portion 1054 and a blade 1050. The tab portion 1054 is dimensioned to fit within the opening 1055 of the first connector piece 1000a. In some configurations, the edges of the tab portion 1054 are configured to engage the side walls of the opening 1055. In some configurations, one or more protrusions 1054a extend from a bottom surface of the tab portion 1054 along the z axis as shown in FIG. 10B. The protrusions 1054a are dimensioned to slidably engage with the channels 1055a. When the tab portion 1054 is inserted in the opening 1055, the blade 1050 extends forwardly along the mating y-axis in the third slot portion 1033 of the assembled connector 1000.

FIG. 10C shows the assembled connector 1000 after the channels 1055a are engaged with the protrusions 1054a. The assembled connector 1000 shown in FIG. 10C can have electrical contacts and other features similar to the configuration of connector 900, for example.

In some embodiments, the plug or socket connectors as described herein can be stacked to form stacked plug connectors or stacked socket connectors. FIG. 11 provides an illustration of a stacked plug connector 1100 including a first connector section 1100a and a second connector section 1100b. Each connector section 1100a, 1100b includes an elongated housing 1101a, 1101b from which a first (bottom) tongue and one or more second (top) tongues extend forwardly along the mating direction. In this embodiment, each connector section 1100a, 1100b includes a first tongue 1110a, 1110b and three second tongues 1121a, 1122a, 1123a, 1121b, 1122b, 1123b, although in other configurations the connector sections can include one second tongue, two second tongues, or more than three second tongues. The gaps 1131a, 1132a, 1133a, 1131b, 1132b, 1133b between the top surface 1111a, 1111b of the first tongue 1110a, 1110b and the bottom surfaces 1141a, 1142a, 1143a, 1141b, 1142b, 1143b of the second tongues 1121a, 1122a, 1123a, 1121b, 1122b, 1123b of the first and/or second connector sections 1100a, 1100b may be in a range of about 0.1 mm to about 5 mm. The distance between the bottom surface 1160a of the first tongue 1110a of the first connector section 1100a and the top surfaces 1151b, 1152b, 1153b of the second tongues 1121b, 1122b, 1123b of the second connector section 1100b are separated by about 1.66 mm.

The first and second connector sections 1100a, 1100b include electrical contacts arranged on the first and second tongues as previously discussed. For example, for the first connector section 1100a, electrical contacts may be arranged on the top and bottom surfaces 1111a, 1160a of the first tongue 1110a and on the top surface 1151a, 1152a, 1153a of the second tongues 1121a, 1122a, 1123a. There may be no electrical contacts on the bottom surfaces 1141a, 1142a, 1143a of the second tongues 1121a, 1122a, 1123a and no electrical contacts on the top surface 1111a of the first tongue 1110a in the regions of the gaps 1131a, 1132a, 1133a where the second tongues 1121a, 1122a, 1123a overlap the first tongue 1110a.

Similarly, for the second connector section 1100b, electrical contacts may be arranged on the top and bottom surfaces 1111b, 1160b of the first tongue 1110b and on the top surface 1151b, 1152b, 1153b of the second tongues 1121b, 1122b, 1123b. There may be no electrical contacts on the bottom surfaces 1141b, 1142b, 1143b of the second tongues 1121b, 1122b, 1123b and no electrical contacts on the top surface 1111b of the first tongue 1110b in the regions of the gaps 1131b, 1132b, 1133b where the second tongues 1121b, 1122b, 1123b overlap the first tongue 1110b.

Embodiments disclosed herein include:

### Item 1

An elongated electrical connector for mounting on a printed circuit board and mating with a mating connector along a mating direction, the connector comprising:

an elongated base extending along a longitudinal direction perpendicular to the mating direction;

first and second end walls extending forwardly along the mating direction from opposite longitudinal ends of the base;

a bottom tongue extending forwardly along the mating direction from the base and disposed between and spaced apart from the first and second end walls, the bottom tongue having a uniform thickness along its length along the longitudinal direction and comprising first and second bottom tongue portions separated by a third bottom tongue portion;

a top tongue extending forwardly along the mating direction from the base and disposed between and spaced apart from the first and second end walls, the top tongue having a uniform thickness along its length along the longitudinal direction and being spaced apart from the bottom tongue along a thickness direction perpendicular to the mating and longitudinal directions, a bottom surface of the top tongue facing a top face of the third bottom tongue portion;

a plurality of spaced apart first contacts disposed on a top surface of the first bottom tongue portion;

a plurality of spaced apart second contacts disposed on a top surface of the second bottom tongue portion;

a plurality of spaced apart third contacts disposed on a bottom surface of the bottom tongue; and

a plurality of spaced apart fourth contacts disposed on a top surface of the top tongue.

### Item 2

The elongated electrical connector of item 1, wherein the top and bottom tongues have the same thickness.

### Item 3

The elongated electrical connector of item 1, wherein the top tongue is thicker than the bottom tongue.

### Item 4

The elongated electrical connector of item 1, wherein the top tongue is thinner than the bottom tongue.

### Item 5

The elongated electrical connector of any of items 1 through 4, wherein a length of the top tongue along the longitudinal direction is smaller than a length of the bottom tongue along the longitudinal direction.

### Item 6

The elongated electrical connector of any of items 1 through 5, wherein a separation between the top and bottom tongues along the thickness direction is in a range from 0.1 mm to 5 mm.

### Item 7

The elongated electrical connector of any of items 1 through 6, wherein there are no contacts on a bottom surface of the top tongue.

### Item 8

The elongated electrical connector of any of items 1 through 7, wherein there are contacts on a bottom, but not top, surface of the third bottom tongue portion.

### Item 9

The elongated electrical connector of any of items 1 through 8, wherein the bottom tongue has a width along the mating direction measured from a front edge of the bottom tongue to the base, the first and second bottom tongue portions having a larger width, the third bottom tongue portion having a smaller width.

### Item 10

The elongated electrical connector of any of items 1 through 9, wherein the base, the top and bottom tongues, and the first and second end walls form a unitary construction.

### Item 11

The elongated electrical connector of any of items 1 through 10, wherein a separation distance between the top and bottom tongues along the thickness direction is variable.

### Item 12

The elongated electrical connector of any of items 1 through 11, wherein the top tongue is reversibly attachable to and removable from the connector.

### Item 13

The elongated electrical connector of item 12, wherein the base comprises a sliding portion, the top tongue extending forwardly along the mating direction from the sliding portion of the base, the base comprising a groove along the thickness direction, the top tongue being reversibly attachable to and removable from the connector by the sliding portion of the base sliding along the groove.

### Item 14

The elongated electrical connector of any of items 1 through 13, wherein the top tongue comprises a plurality of spaced apart slots, each slot extending from the top surface to a bottom surface of the top tongue, each contact in the plurality of fourth contacts being disposed on a corresponding slot.

### Item 15

The elongated electrical connector of any of items 1 through 14, further comprising an insert removably inserted in a gap defined between the spaced apart top and bottom tongues, the insert providing support to the top tongue.

### Item 16

The elongated electrical connector of item 15, wherein the insert is removed before the connector mates with a mating connector.

### Item 17

The elongated electrical connector of any of items 1 through 16, wherein each of the first and second end walls includes a U-shaped channel configured to slidably engage with a mating connector.

### Item 18

An electrical connector comprising:

a unitary base elongated along a longitudinal direction;

a first tongue extending forwardly from the base and having a uniform thickness along the longitudinal direction, the first tongue comprising a plurality of spaced apart first contacts;

a second tongue extending forwardly from the base and comprising a plurality of spaced apart second contacts, the first and second tongues defining a gap therebetween that extends from a front edge of one of the first and second tongues toward the unitary base.

### Item 19

The electrical connector of item 18, wherein the gap extends from the front edge of one of the first and second tongues to the unitary base.

### Item 20

The electrical connector of any of items 18 through 19, wherein the first tongue has a width measured from a front edge of the first tongue to the unitary base, the width being substantially the same across the length of the first tongue.

### Item 21

The electrical connector of any of items 18 through 20, wherein each of the first and second tongues has a length along the longitudinal direction, the length of the first tongue being greater than the length of the second tongue.

### Item 22

The electrical connector of any of items 18 through 21, wherein each of the first and second tongues has a length along the longitudinal direction and a width measured from a front edge of the tongue to the base, each of the first and second tongues having a uniform thickness across the width and length of the tongue.

### Item 23

The electrical connector of any of items 18 through 22, wherein the first and second tongues define an overlap region between the two tongues, wherein in the overlap region, each tongue comprises contacts only on one major surface of the tongue.

### Item 24

The electrical connector of any of items 18 through 23, wherein the first and second tongues define an overlap region between the two tongues, wherein in the overlap region, neither tongue comprises contacts on a major surface of the tongue that faces the other tongue.

### Item 25

The electrical connector of any of items 18 though 24, wherein the first and second tongues define an overlap region between the two tongues, wherein in the overlap region, each tongue comprises contacts only on a major surface of the tongue that faces away from the other tongue.

### Item 26

An electrical connector comprising:

a unitary housing elongated along a longitudinal direction perpendicular to a mating direction of the connector, the unitary housing defining a central slot extending along the longitudinal direction, the central slot comprising first and second slot portions separated by a third slot portion, each slot portion comprising opposing top and bottom surfaces, a separation between the top of bottom surfaces of each slot portion along a thickness direction orthogonal to the longitudinal and mating directions defining a height of the slot, the first and second slot portions having a same smaller height, the third slot portion having a greater height, the unitary housing comprising a blade extending forwardly along the mating direction from a back surface of the third slot portion and disposed between and spaced apart from the top and bottom surfaces of the third slot portion;

a plurality of spaced apart first contacts disposed on a top surface of the first slot portion;

a plurality of spaced apart second contacts disposed on a top surface of the second slot portion;

a plurality of spaced apart third contacts disposed on bottom surfaces of the first, second and third slot portions; and

a plurality of spaced apart fourth contacts disposed on a top surface of the third slot portion.

### Item 27

The electrical connector of item 26, wherein the bottom surfaces of the first, second and third slot portions lie in a sample plane.

### Item 28

The electrical connector of any of items 26 through 27, wherein the top surfaces of the first and second slot portions lie in a same plane and the top surface of the third slot portion lies in a higher plane.

### Item 29

The electrical connector of any of items 26 through 28, wherein the blade does not extend into the first and second slot portions.

### Item 30

The electrical connector of any of items 26 through 29, wherein when the connector mates with a mating connector having spaced apart top and bottom tongues defining a gap therebetween, the first and second slot portions mate with the bottom tongue, the third slot portion mates with the top tongue, and the blade is inserted in the gap.

### Item 31

An electrical connector comprising a unitary insulative housing defining an elongated slot bound by opposing first and second major surfaces and comprising a blade extending from a back surface of the slot toward a front of the slot and disposed between and spaced apart from the first and second major surfaces, a first plurality of contacts disposed on the first major surface and facing the blade, a second plurality of contacts disposed on the second major surface and facing the blade.

### Item 32

The electrical connector of item 31, wherein the blade does not carry any contacts.

### Item 33

An electrical connector adapted to mate with a mating connector that includes overlapping planar top and bottom tongues defining a gap therebetween with each tongue carrying a plurality of contacts, the electrical connector comprising an insulative planar blade, such that when the electrical connector mates with the mating connector, the insulative planar blade is inserted in the gap to provide support to at least one of the top and bottom tongues.

### Item 34

The electrical connector of item 33, wherein the blade does not carry any contacts.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Various modifications and alterations of this invention will be apparent to those skilled in the art and it should be understood that this scope of this disclosure is not limited to the illustrative embodiments set forth herein. For example, the reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. An electrical connector comprising:
a unitary housing elongated along a longitudinal direction perpendicular to a mating direction of the connector, the unitary housing defining a central slot extending along the longitudinal direction, the central slot comprising first and second slot portions separated by a third slot portion, each slot portion comprising opposing top and bottom surfaces, a separation between the top of bottom surfaces of each slot portion along a thickness direction orthogonal to the longitudinal and mating directions defining a height of the slot, the first and second slot portions having a same smaller height, the third slot portion having a greater height, the unitary housing comprising a blade extending forwardly along the mating direction from a back surface of the third slot portion and disposed between and spaced apart from the top and bottom surfaces of the third slot portion;
a plurality of spaced apart first contacts disposed on a top surface of the first slot portion;
a plurality of spaced apart second contacts disposed on a top surface of the second slot portion;
a plurality of spaced apart third contacts disposed on bottom surfaces of the first, second and third slot portions; and
a plurality of spaced apart fourth contacts disposed on a top surface of the third slot portion.

2. The electrical connector of claim 1, wherein the bottom surfaces of the first, second and third slot portions lie in a sample plane.

3. The electrical connector of claim 1, wherein the top surfaces of the first and second slot portions lie in a same plane and the top surface of the third slot portion lies in a higher plane.

4. The electrical connector of claim 1, wherein the blade does not extend into the first and second slot portions.

5. The electrical connector of claim 1, wherein when the connector mates with a mating connector having spaced apart top and bottom tongues defining a gap therebetween, the first and second slot portions mate with the bottom tongue, the third slot portion mates with the top tongue, and the blade is inserted in the gap.
